(19) United States
(12) Patent Application Publication
(10) Pub. No.: US 2007/0165761 A1
(43) Pub. Date: Jul. 19, 2007

(54) Method and system for universal sampling rate conversion

(75) Inventors: Mikhail U. Yagunov, Pompano Beach, FL (US); Charbel Khawand, Miami, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/292,499

(22) Filed: Nov. 29, 2005

(51) Int. Cl. H04L 7/00

(52) U.S. Cl. 375/372

(57) ABSTRACT

A sampling rate converter (100) is provided. The system can include a data buffer (102), a processor (104) for processing data in the buffer (10), and a plurality of sampling rate lines for configuring the processor. For example, the input signal can have an input sampling frequency corresponding to a first sampling rate line (110) and an output signal having an output sampling frequency corresponding to a second sampling rate line (112). The processor (104) can convert the input samples corresponding to the first sampling rate to output samples corresponding to the second sampling rate using a single filter (700). The first line (110) can include approximate sampling rates of 8 kHz, 16 kHz, 32 kHz, and 64 kHz; the second line (112) can include approximate sampling rates of 12 kHz, 48 kHz, and 96 kHz; and the third line (114) can include approximate sampling rates of 11.025 kHz, 22.05 kHz, and 44.1 kHz.

### FIELD OF THE INVENTION

The embodiments herein relate generally to methods and systems that process signals and more particularly to methods and systems that adjust the sampling rate of a speech or audio signal.

### DESCRIPTION OF THE RELATED ART

The use of portable electronic devices has increased in recent years. Cellular telephones, in particular, have become commonplace with the public. Many of these mobile devices support multimedia features that require audio processing capabilities for playing speech, music, and sounds at various sampling rates. Various media devices support various sampling rates, though the audio processing system on the device requires knowledge of the sampling rate particular to the audio file to correctly play the audio. The audio file can be contained within the device or downloaded to the device over a streaming connection. Presently, mobile devices support a number of fixed sampling rates and must identify the sampling rate of the audio media to properly play the audio.

Manufacturers of mobile devices are interested in supporting the various media formats such as WAV, MP3, OGG, AAC, and WMA to name a few, with each supporting various sampling rates. Compatibility is an important issue to manufacturers which allows devices to intercommunicate amongst themselves for transferring data. Accordingly, manufacturers are interested in audio processing devices that support various formats. Mobile devices can include Sampling Rate Converters (SRC) for changing the sampling rate of a media type to a sampling rate supported by the audio processing system. However, for interoperability between the various multimedia streams, it may be preferable to use a common sampling rate for the various multimedia systems. Sampling at different rates can require reprogramming a codec. Also, voice processors generally sample speech at 8 KHz, a roll over from the days of the analog systems where the bandwidth was limited to 4 Khz. Speech contains salient features below 4 Khz which makes the 8 KHz sampling rate sufficient for voice encoding. However, multimedia components within the mobile devices support higher sampling rates, and changing the sampling rate on the codec to support different rates can be inefficient or impractical. For example, when mixing speech with music, it may be necessary to convert the audio formats to a common sampling rate in order to mix the audio and play the audio out of a speaker using only one codec.

Most SRC's employ a multi-stage filtering approach of interpolation followed by decimation to realize the sampling rate conversion. However, the multi-stage procedure may require a custom setting for the interpolation and decimation rate each time a conversion is requested. If only one conversion ration is required, the multi-stage approach is practical. The multi-stage SRC approach can use an up-sampling filter with ratio of L followed by a down-sampling filter with ratio of M, where L/M determines the conversion ratio. However, L and M could be large in order to achieve the conversion ratio. Accordingly, several final conversion ratios may be needed since filter lengths are limited, which each require a two-stage filtering approach. A set of up sampling and down sampling filters may be necessary for each different sampling rate conversion and each of which occupies its own length in memory. One problem with the multi-stage approach arises when a number of conversion ratios are needed. For example, each conversion ratio can require a separate-set of filter coefficients which can consume storage space in the memory limited mobile device.

### SUMMARY

The embodiments of the invention concern a method and system for universal sampling rate conversion. The method includes the steps of receiving input samples at a first sampling rate on a first data buffer, and processing the input samples for converting the input samples corresponding to the first sampling rate to output samples corresponding to a second sampling rate. For example, the system receives a first data frame of input samples on a first data buffer from a codec at a first sampling rate and the processor places output samples in a second data frame on the second data buffer for playing out by a codec at a second sampling rate. The processing can be accomplished by a single filter using a single table of coefficients that performs the sampling rate conversion directly on the input signal.

The processing step can include accessing filter coefficients in a table stored in a memory which can also include incrementally indexing into the table. The method can also include establishing a number of zero crossings in the table for increasing and decreasing a filter slope, where the slope can correspond to a filter response of the filter coefficients. The number of coefficients per zero crossing can control the precision of conversion. The method can also include establishing a step size for incrementally indexing into the table of filter coefficients, where the step size can shift the filter response cutoff frequency for up-sampling and down-sampling to suppress aliasing effects during the sampling rate conversion. Additionally, the step of processing can further include identifying a frame boundary for ensuring the number of input samples received and the output samples processed correspond to a sampling rate conversion ratio. For example, the sampling rate conversion ratio can include an integer portion and a floating portion. The method can include filtering up to the frame boundary for preparing a number of output samples on the second frame that equals a fixed proportion of the number of input samples in the first frame. The method can also include setting a guard value to limit a frequency response cutoff during sampling rate conversion for controlling the amount of aliasing. The guard value can suppress high frequency content to suppress aliasing effects.

The embodiments of the invention also concern a selectable sampling rate conversion. The system can include a data buffer, a processor for processing data in the buffer, and a plurality of lines for configuring the processor. For example, the input signal can have an input signal having an input sampling frequency corresponding to at least one of the sampling rate lines, and an output signal having an output sampling frequency corresponding to at least one of the sampling rate lines. The processor can convert the input samples corresponding to the first sampling rate to output samples corresponding to the second sampling rate using a single filter. The output signal can also have an output sampling frequency corresponding to at least one of the first line, second line, and third line. For example, a first line comprises sampling rates of 8 kHz, 16 kHz, 32 kHz and 64 kHz; a second line comprises sampling rates of 12 khz, 48 kHz, and 96 kHz; a the third line comprises sampling rates of 11.025 kHz, 22.05 kHz, and 44.1 kHz. The system can further include a memory for storing a table of filter coefficients where the processor performs sampling rate conversion in real-time by incrementally indexing into the table of filter coefficients. To reduce memory, the table contains half the number of coefficients necessary to realize one side of a sinc function (i.e. a cardinal sine function), the sinc function having two sides that are each symmetric to one another for providing linear phase characteristics. It should be noted that the method can convert any sampling rate to any sampling rate, and is not limited to discrete line rate conversions.

The embodiments of the invention also concern a system for universal sampling rate conversion. The system can include a first data buffer for receiving input samples at a first sampling rate, a processor for processing the input samples in the first data buffer, for converting the input samples corresponding to the first sampling rate to output samples corresponding to a second sampling rate. For example, the processor receives a first data frame of the input samples on the first data buffer, where the processor places output samples in a second data frame on the second data buffer. The processor includes a single filter that indexes a single set of coefficients stored in a table.

The system can further include a memory for storing a table of filter coefficients accessible to the processor, and a codec for placing input samples on the first data buffer and for removing output samples on the second data buffer. For example, the codec places a first frame of input samples on the first data buffer at the first sampling rate, the processor prepares a second frame on the second data buffer for access by a second codec sampling the second data buffer at the second sampling rate, where the processor indexes filter coefficients from the table. In one arrangement, the first codec and second codec can be the same, where the codec uses a first sampling rate when placing the first frame, and uses a second sampling rate when removing the second frame.

The system can also include a zero crossing control for setting a filter slope corresponding to a filter response. For example, the zero crossing control establishes the number of zero crossings permitted in the table of filter coefficients, where the number of zero crossings are the number of times the filter coefficients in the table change sign. The system can also include a step size control for incrementally indexing into the table of filter coefficients, where the step size sets a filter cutoff that suppresses aliasing effects during the sampling rate conversion. The processor can sets a boundary between the first data frame and the second data frame for complying with a sampling rate conversion ratio. The sampling rate conversion ratio can include an integer portion and a floating portion, where the processor filters up to the boundary for preparing a number of output samples on the second frame that equals a fixed proportion of the number of input samples in the first frame. For example, an input buffer can have a first frame size, and an output buffer can have a second frame size. The ratio of the frame sizes may not be an integer multiple. Accordingly, there will be samples left over during a frame conversion that need to be additionally processed. The left over samples can represent the fractional part. The system can perform universal sampling rate conversion in real-time.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a system for sampling rate conversion in accordance with an embodiment of the inventive arrangements;

FIG. 2 depicts a portion of memory for the system of FIG. 1 in greater detail in accordance with an embodiment of the inventive arrangements;

FIG. 3 illustrates a method for sample rate conversion in accordance with an embodiment of the inventive arrangements;

FIG. 4 illustrates a method for configuring the system of FIG. 1 in accordance with an embodiment of the inventive arrangements;

FIG. 5 illustrates changing a cutoff using a zero cross control in accordance with an embodiment of the inventive arrangements;

FIG. 6 illustrates changing a filter slope using a step size control in accordance with an embodiment of the inventive arrangements;

FIG. 7 illustrates a signal plot for a single filter for sample rate conversion in accordance with an embodiment of the inventive arrangements; and

FIG. 8 illustrates a detailed approach of the filter in FIG. 7 for sample rate conversion in accordance with an embodiment of the inventive arrangements

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The embodiments of the invention concern a method and system for universal sampling rate conversion. The method includes the steps of receiving input samples at a first sampling rate on a first data buffer and processing the input samples for converting the input samples corresponding to the first sampling rate to output samples corresponding to a second sampling rate. For example, the system receives a first data frame of input samples on a first data buffer from a codec at a first sampling rate and the processor places output samples in a second data frame on the second data buffer for playing out by a codec at a second sampling rate. The processing can be accomplished by a single filter using a single table of coefficients that performs the sampling rate conversion directly on the input signal.

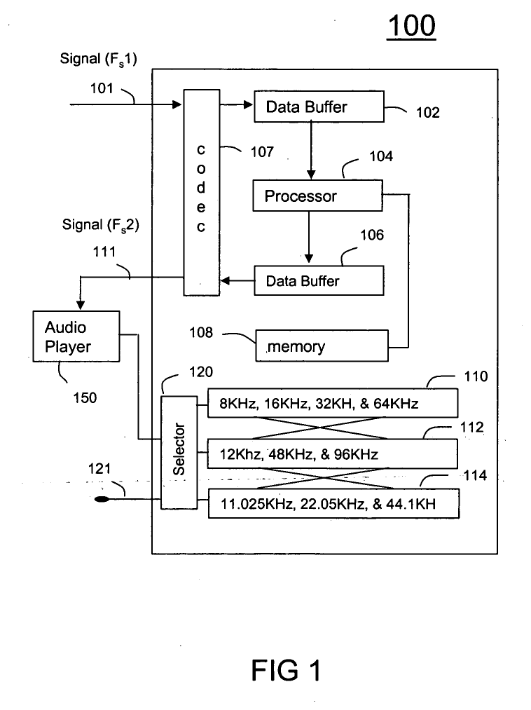

Referring to FIG. 1, a system 100 for sampling rate conversion is shown. The system 100 can include a first data buffer 102, a processor 104, and a second data buffer 106. The system can also include an encoder/decoder (codec) 107 and a memory 108. Briefly, the processor 104 can receive a first audio signal 101 from the codec 107 and process the first audio signal 101 using filter coefficients stored in the memory 108 for performing sampling rate conversion. For example, a first audio signal 101 can be input to the system 100 corresponding to a first sampling rate Fs1. The system can convert the first audio signal 101 from the first sampling rate to a second audio signal 111 with a second sampling rate, Fs2. The encoder 107 can output the second audio signal 111 corresponding to the second sampling rate to an audio player 150 which receives the output audio in a sampling rate format that the audio player 150 supports. Briefly, the processor 104 can convert the sampling rates with a single filter using filter coefficients stored in the memory 108.

In one arrangement, the system 100 can also include a plurality of sampling rates 110 for configuring the processor, a second line of sampling rates 112 for configuring the processor, and a third line of sampling rates 114 for configuring the processor. The system can include a selector 120 for selecting sampling rate conversion ratios. The selecting of the sampling rate conversion ratios can be automatic or manual. For example, the selector 120 can automatically determine an input sampling rate by reading a descriptive header in the audio file. The selector 120 can also determine the output sampling rate by issuing an inquiry to an audio player 150 that is receiving the output signal 111. For example, the audio player 150 supports sampling rates that can be made available to the system 100. A user can manually select 121 the input sampling frequency and output sampling frequency.

In one arrangement, the first line can comprise approximate sampling rates of 8 kHz, 16 kHz, 32 kHz, and 64 kHz, the second line can comprise approximate sampling rates of 12 khz, 48 kHz, and 96 kHz, and the third line can comprise approximate sampling rates of 11.025 kHz, 22.05 kHz, and 44.1 kHz. For example, a first audio signal (101) can have a first audio sampling frequency corresponding to at least one of the first line, second line, and third line. The first audio signal (101) can be on the first data buffer 102. The processor 104 can convert the input samples corresponding to the first sampling rate of the first audio signal 101 to output samples corresponding to a second sampling rate of a second audio signal rate. The output signal can also have an output sampling frequency corresponding to at least one of the first line, second line, or third line. The processor 104 can convert the sampling rates with a single filter.

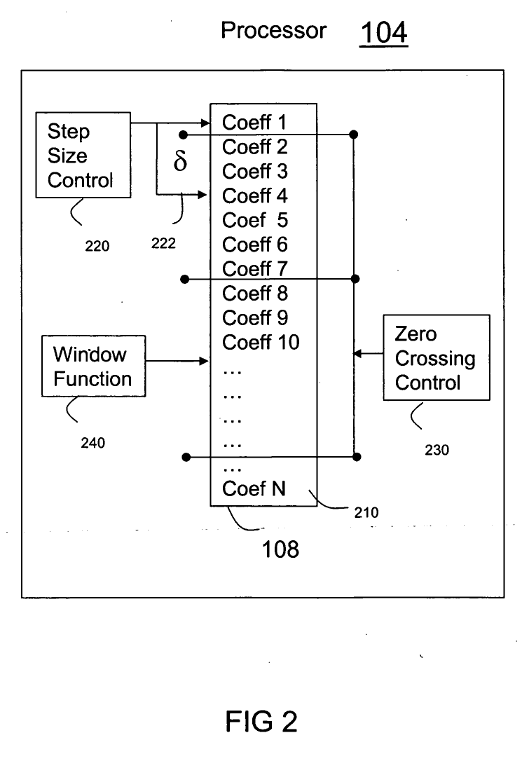

Referring to FIG. 2, a detailed portion of the processor 104 of system 100 is shown. In one arrangement, the processor 104 can include a table of coefficients 210, a step size control 220, a zero crossing control 230, and a window function 240. The table of coefficients can be stored in the memory 108. The step size control 220 can be coupled to the table 210 for setting a step size ( [symbol] for incrementally indexing into the table 222. The zero crossing control 230 can be coupled to the table 210 for establishing a number of zero crossings in the table 210 for increasing and decreasing a filter slope, the slope corresponding to a filter response of the filter coefficients in the table 210. Briefly, the step size control 220 determines what coefficients are used in generating a filter for sampling rate conversion. The step size control 220 and zero crossing control 230 tell the processor 104 what coefficients and how many of the coefficients to use during the sample rate conversion. Briefly, a filter in the processor 104 uses the filter coefficients indexed by the step size control 220. The processor incrementally indexes into the table 210 up until it reaches a certain zero crossing specified by the zero crossing control 230. The processor applies a filter specified by the indexed coefficients.

The window function 240 applies a window to the coefficients stored in the table 210 any time the zero crossing control changes 230. The zero crossing control 230 is also cooperatively coupled to the selector 120 and can change whenever the selector changes the sampling rate ratio. For example, the selector can update the sampling rate ratio when the system 100 receives a new audio file. Typically, the selector 120 automatically changes the sampling rate when it encounters a new audio media, which changes the zero crossing control 230, and which changes the window function 240 applied to the coefficients stored in the table 210.

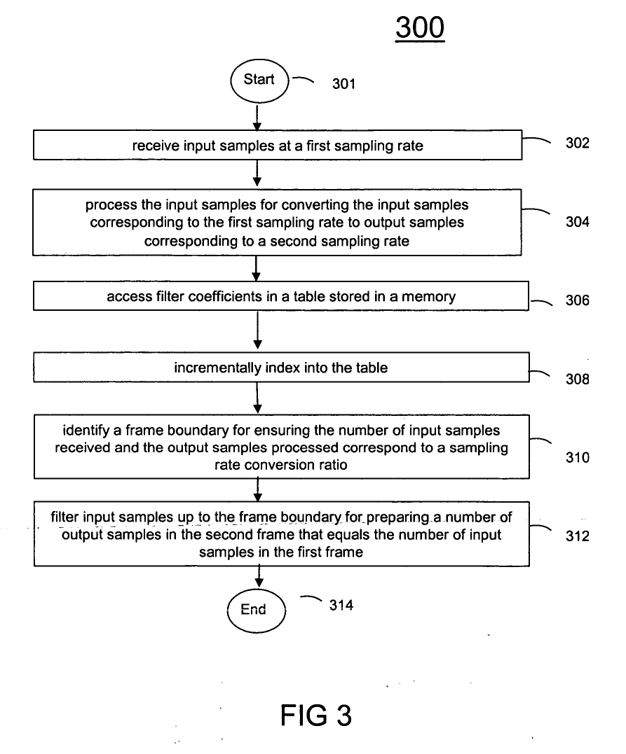

Referring to FIG. 3. a method 300 for sample rate conversion is shown. To describe the method 300, reference will be made to FIGS. 1 and 2, although it is understood that the method 300 can be implemented in any other suitable device or system using other suitable components. Moreover, the method 300 is not limited to the order in which the steps are listed in the method 300. In addition, the method 300 can contain a greater or a fewer number of steps than those shown in FIG. 3.

At step 301, the method 300 can start. At step 302, input samples can be received on first data buffer. For example, referring to FIG. 1, the codec 107 can place input samples from a first audio signal 101 on the first data buffer 102. At step 304, the input samples can be processed for converting the sampling rate of the input signal to a second sampling rate. Referring to FIG. 2, the processor 104 converts the input samples corresponding to the first sampling rate to output samples corresponding to a second sampling rate. For example the processor 104 converts the input samples on the first data buffer 102 from one sampling rate to output samples corresponding to a second sampling rate on a second data buffer 106. In one arrangement, the processor 104 receives a first data frame of the input samples on the first data buffer 102, and the processor 104 places the output samples in a second data frame on the second data buffer 106.

At step 306, filter coefficients are accessed in a table stored in memory. Referring to FIG. 2, the processor 104 accesses filter coefficients in the table 210 saved in memory 108. The processor 104 can perform a one-step filtering operation using a single Finite Impulse Response (FIR) for sampling rate conversion and uses the filter coefficients in the table 210 for the filter taps. A detailed description of the single FIR algorithm will follow shortly. At step 308, the filter coefficients within the table can be incrementally indexed. Referring to FIG. 2, the step size control 220 selects a step size for incrementally indexing into the table. For example, a step size of 2 would select every other filter coefficient in the table. The processor 104 selects the step size after the selector 120 determines the correct sampling ratio to use. For example, the selector 120 can determine an input sampling rate of 8 kHz and an output sampling rate of 48 kHz. The processor 104 selects a step size correspondingly mapped to the conversion ratio 48/8 within the selector 120.

The sampling rate conversion ratio can also include an integer portion and a floating portion. Each conversion ratio is mapped to a step size within selector 120. For example, the selector 120 selects a first line for the 8 khz input signal and the second line for the 48 kHz output signal. The selector 120 contains an associated index of step sizes for each sampling rate mapping. For this reason, FIG. 1 shows a diagonal cross between each of the three sampling rate lines 110, 112, and 114 to denote that the selector has mapped the sampling rate ratios to step sizes. The selector 120 communicates with the step size controller 220 to inform the controller 220 of what step size the processor 104 will require for the sampling rate conversion.

At step 310, a frame boundary can be identified for ensuring the number of input samples received and the output samples processed correspond to a sampling rate conversion ratio, wherein the sampling rate conversion ratio can include an integer portion and a floating portion. Referring to FIG. 2, the system 100 can perform real time processing on a frame by frame bases. In a real-time frame processing system each frame of input data received can produce a frame of output data. In an SRC system the number of samples are different between the input frames and the output frames depending on the sampling rate. For example, in one case the number of output frames can be double the number of input samples. The difference can also be fractional when the sampling rate conversion is non-integer. In this example, each input sample requires two processes for producing two output samples for each input sample. Accordingly, the processor 104 imposes a frame boundary to determine how far the filtering should run to satisfy the real time processing constraints. At step 312, input samples are filtered up to a frame boundary. Referring to FIG. 2, the processor 104 filters up to a frame boundary demarcated along the first data buffer 102 for preparing a number of output samples on the second frame that equals a fixed proportion of the number of input samples in the first frame. The zero crossing control 230 sets the number of zero crossings based on a required steepness of the frequency response slope. For example, a low sample rate conversion may require a steep slope whereas a high sample rate conversion may require a relaxed slope. The number of zero crosses permitted in the table 210 describe the filter resolution and accordingly the filter slope. The zero crossing detector 230 can assign more zero crossings for more control on the filter slope. The zero cross controller 230 receives the sampling conversion ratio from the selector 120 to set the number of zero crosses.

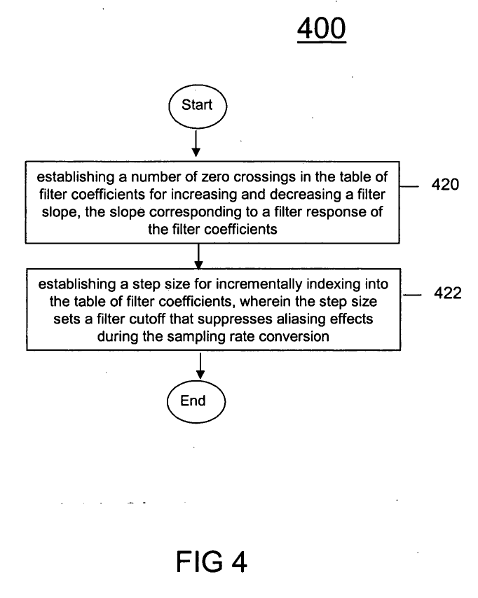

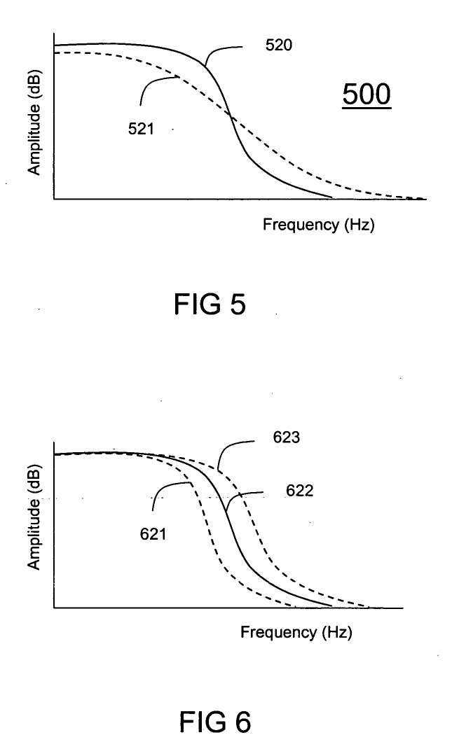

Referring to FIG. 4. a method 400 for configuring the processor is shown. Reference will be made to FIGS. 5, 6, and 8 for describing the method 400. The method 400 can be practiced in any other suitable system or device. The configuration of the processor can occur during sample rate conversion or before sample rate conversion begins. In the disclosed embodiment, the method 400 of configuring is applied before sample rate conversion.

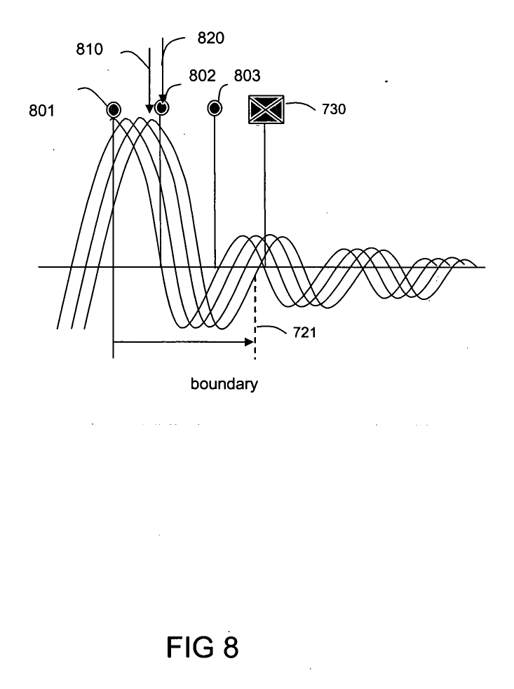

At step 420, a number of zero crossings is established in the table of filter coefficients for increasing and decreasing a filter slope, the slope corresponding to a filter response of the filter coefficients for sampling rate conversion. For example, referring to FIGS. 2 and 5, a frequency response 500 of the filter is shown. The filter is represented by the filter coefficients indexed in the table 210 through the step size control 220 and up to the zero crossing position set by the zero crossing control 230. The zero crossing controller 230 increases the number of zero crossings in the table 108 to increase the filter slope 520. Similarly, the crossing controller 230 decreases the number of zero crossings in the table 108 to decrease the filter slope 521. During filtering of the input signal 101 for sampling rate conversion, the processor 104 indexes filter coefficients up until the point in the table at which the boundary 721 (in FIG. 8) denoted by the number of zero crossings set by the zero crossing control 230 is reached.

At step 422, a step size for incrementally indexing into the table of filter coefficients is established, where the step size sets a filter cutoff that suppresses aliasing effects during the sampling rate conversion. For example, referring to FIGS. 2 and 6, a frequency response 622 of the filter is shown. The filter is represented by the filter coefficients indexed in the table 210 through the step size control 220 and up to the zero crossing position set by the zero crossing control 230. For example, the step size control 220 increases the step size for decreasing temporal resolution of the filter to decrease the bandwidth cut off frequency 621, i.e. the bandwidth decreases which reduces aliasing effects. Similarly, the step size control 220 decreases the step size for increasing temporal resolution of the filter to increase the bandwidth cutoff frequency 623, i.e. bandwidth increases.

Referring to FIG. 2, the selector 120 determines an input sampling rate at the input 101 and an output sampling rate supported by the audio player 150 at the output 111. The processor 104 can calculate a conversion ratio of the input rate to output rate. Based on the conversion ratio, the processor 104 selects a step size correspondingly mapped to the conversion ratio. The processor 104 filters the input signal 101 using filter coefficients indexed by the step size in the table 210 and filters up until a boundary is reached. The processor 104 filters the input signal 101 for each input frame of speech. In one arrangement, the processor can access up to 3 frames of data. In real-time processing the input data 101 arrives in a frame format. Accordingly, for any given moment in time only the samples available from the current (received) frame of speech and past frames of input are available. The processor 104 can filter a number of input samples in fixed proportion to a number output samples, where the proportion is set by the sampling rate conversion ratio. However, the filtering may only have a fixed number of input samples available in the current frame. The processor 104 therefore continues processing even though input data is not present in order to provide the required number of fixed output samples.

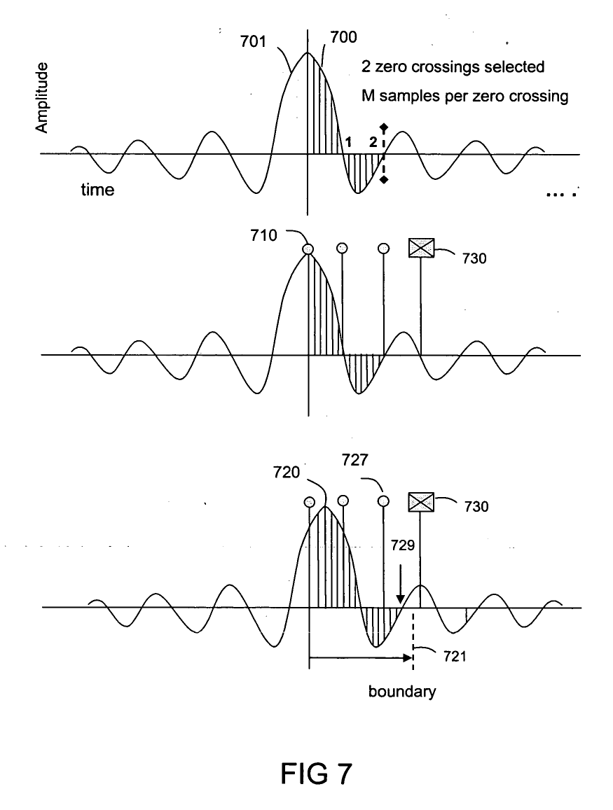

For example, referring to FIG. 7, the processor 104 filters input samples up until the boundary 721, even though no input samples are present. For example, there are no input samples between 727 and 730, though there are output samples defined by vertical lines on the sinc function 701 (cardinal sine function). The processor 104 employs a filter with finer resolution (higher number of samples) than the input sampling rate. Accordingly, the output sampling rate can have samples between 727 and 730 which requires the filter to process data within this region. The sinc function performs an interpolation on samples based on the center (the highest amplitude point in the sinc function) and requires input samples which fit within the sample limits of the sinc function 700. The zero crossing controller 230 sets the sinc function limits to a number of zero crossings. For example, the number of discrete vertical lines under the sinc function 700 reveal the sampling resolution of the filter and only go up until the number of zero crossings limit. Accordingly, the processor 104 filters up until the point at which the sinc limit 729 (i.e., the number of zero crossings set by the zero crossing controller) reaches the boundary 721. The processor 104 effectively filters data between the last available sample 727 up until the first unavailable sample 730. The input sample 730 is unavailable because the frame has not yet been received in real-time. The processor 104, moves the filter along the input samples until the sinc limit 729 (number of filter zero crossings) reaches the boundary 721, where the boundary corresponds to the last filter sample set by the zero cross controller 230. The processor 104 can also set the resolution (number of filter coefficients) of the filter to be equal to a sampling rate conversion ratio.

Referring to FIG. 7. an illustration for understanding the sampling rate converter described by methods 300 and 400 is shown. Each plot shows a continuous symmetric sinc function with a left wing 701 and a right wing 700. The top plot shows the right wing sinc function 700 sampled up until the second zero crossing, which occurs at location 2. With reference to FIG. 2, the zero crossing control 230 sets this zero crossing location. There are also M samples spaced between each zero crossing. The number of samples is fixed between each zero crossing, where each sample is represented as a vertical line under the right wing 700 of the sinc function. The number of zero crossings being the number of times the filter coefficients in the table change sign. With reference to FIG. 2, the step size controller 220 determines which samples in the continuous sinc function are selected, and accordingly the resolution of the sample spacing. Note, the continuous sinc function is sampled at 512 samples per zero crossing with 24 zero crossing locations and stored in the table 108 as an over sampled sinc function.

The middle plot shows the sinc function in the context of an input signal. Samples of the input signal are noted with shaded circles on top resembling lollipops. With reference to FIG. 2, the processor 104 will convolve the two-sided sinc function with the discrete samples of the input signal. In practice only one side is needed since the sinc function is symmetric. Accordingly, the right wing 701 can be stored in memory. For illustration, the input signal is only represented by 3 samples starting at 710. The cross box 730 denotes that this sample is part of the next frame of audio data and has not been received. During convolution, the sinc function will be shifted from left to right across the input signal starting at location 710 to the sample before 730.

The bottom plot shows how far the sinc function can be shifted before it encroaches on the unavailable sample 714. The sinc function can be convolved with the input signal up until the sample just before 714. In effect, the convolution is a weighted sum of input samples where the weighting is the envelope of the sinc signal in accordance with Shannon's resampling theorem that states that a signal can be uniquely reconstructed from its samples.

Referring to FIG. 8, an illustration showing the shifting of the sinc function during convolution is shown. In summary, referring to FIG. 2, the selector 120 will determine appropriate sampling rate conversion ratios based on the input signal and output signal. The zero crossing control 230 will set a number of zero crossings using a zero crossing mark in the table based on the conversion ratio to establish the slope of the filter's frequency response. The zero crossing mark in the table also determines the boundary region on the input data buffer. For example, the boundary region is defined as the last sample the filter can use for producing an output sample. The location of the last sample depends on the sampling rate conversion ratio. The boundary is set with regard to the output sampling rate and may not coincide with discrete sampling locations of the input signal.

For example, the processor 104 filters the input samples 801, 802, and 803 with the sinc function. The center point of the sinc function is the location at which the output sample will be generated. The filtering applies a weighting of the input samples based on the amplitude of the since function where the sinc function overlaps with the discrete input samples. The processor 104 places the output sample on the second buffer at a location described by the center sinc point. For example, at point 810, the input samples 802 and 803 will be used in calculating the output. The processor 104 moves the sinc function up until the last zero crossing before the next un-arrived input sample 730. The processor can move the center tap of the sinc function to the last output sample just before the boundary is reached. However, at location 820, the filter will cease processing since it relies on the un-available input sample. Accordingly, the processor 104 has processed a sufficient number of output samples to comply with the output frame size specified by the sampling rate conversion ratio. The processor 104 waits for the next frame of input samples to be received and processes the input samples similarly to the previous frame processing.

The window function 240 applies a window to the entire table of filter coefficients based on the number of zero crossings selected. The window function is applied to avoid spectral leakage due to under-sampling. The step size control 220 sets a filter cutoff to suppress aliasing effects during the sampling rate conversion. It establishes an incremental index into the table of filter coefficients based on the sampling conversion ratio. The processor indexes into the table of filter coefficients 108 based on the step size to retrieve the filter coefficients as it is filtering the input signal. The processor extracts the filter coefficients up until the index exceeds the zero crossing mark. The processor continues to filter the signal until the boundary at which point no more samples are available for processing. In one particular arrangement the system 100 for sampling rate conversion can convert an audio file from one sampling rate to another sampling rate. The system 100 can alternatively perform the sampling rate conversion in real-time on the device.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A system for sampling rate conversion, comprising:
a first data buffer for receiving input samples at a first sampling rate; and
a processor for processing the input samples in the first data buffer, and for converting the input samples corresponding to the first sampling rate to output samples corresponding to a second sampling rate in a second data buffer;
wherein the processor receives a first data frame of the input samples on the first data buffer and the processor places output samples in a second data frame on the second data buffer.

2. The system of claim 1, wherein the processor is a single filter that indexes a single set of coefficients stored in a table.

3. The system of claim 1, further comprising:
a memory for storing a table of filter coefficients accessible to the processor wherein the processor indexes filter coefficients from the table; and
a codec for placing input samples on the first data buffer and for removing output samples in the second data buffer,
wherein the codec places a first frame of input samples on the first data buffer at the first sampling rate, the processor prepares a second frame on the second data buffer for access by the codec that samples the second data buffer at the second sampling rate.

4. The system of claim 3, wherein the first sampling rate can be provided by a first codec, and the second sampling rate can be provided by a second codec.

5. The system of claim 3, wherein the processor further includes a zero crossing control for setting a filter slope corresponding to a filter response and controlling the precision of the conversion, wherein the zero crossing control establishes the number of zero crossings permitted in the table of filter coefficients, the number of zero crossings being the number of times the filter coefficients in the table change sign and controlling the slope.

6. The system of claim 3, wherein the processor further includes a step size control for incrementally indexing into the table of filter coefficients, wherein the step size shifts the filter response cutoff frequency for up-sampling and down-sampling to suppress aliasing effects during the sampling rate conversion and

7. The system of claim 1, wherein the processor sets a boundary between the first data frame and the second data frame for complying with a sampling rate conversion ratio and filters up to the boundary, wherein the sampling rate conversion ratio can include an integer portion and a floating portion.

8. The system of claim 1, wherein the processor performs sampling rate conversion in real-time.

9. A method for sample rate conversion, comprising the steps of:
receiving input samples at a first sampling rate on a first data buffer;
processing the input samples for converting the input samples corresponding to the first sampling rate to output samples corresponding to a second sampling rate, the output samples placed on a second buffer.
wherein the step of processing receives a first data frame of the input samples on the first data buffer and places output samples in a second data frame on the second data buffer.

10. The method of claim 9, wherein the processing further comprises the step of accessing filter coefficients in a table stored in a memory.

11. The method of claim 10, wherein the step of accessing filter coefficients further comprises incrementally indexing into the table to enable the method of sampling rate conversion in real-time.

12. The method of claim 10, wherein the processing further includes establishing a number of zero crossings in the table of filter coefficients for increasing or decreasing a filter slope, the slope corresponding to a filter response of the filter coefficients.

13. The method of claim 11, wherein the processing further includes establishing a step size for incrementally indexing into the table of filter coefficients, wherein the step size sets a filter cutoff that suppresses aliasing effects during the sampling rate conversion.

14. The method of claim 9, wherein the step of processing further includes identifying a frame boundary for ensuring the number of input samples received and the output samples processed correspond to a sampling rate conversion ratio, wherein the sampling rate conversion ratio can include an integer portion and a floating portion.

15. The method of claim 14, wherein the step of processing further includes filtering the input samples up to the frame boundary for preparing a number of output samples on the second frame that equals a fixed proportion of the number of input samples in the first frame.

16. The method of claim 13, wherein the step of processing further includes setting a guard value to limit a frequency response cutoff during sampling rate conversion for suppressing aliasing effects, wherein the guard value is applied to the step size control for controlling the amount of aliasing in expense of unwanted high frequencies attenuation

17. A selectable sampling rate converter, comprising:
a data buffer;
a processor for processing data in the buffer; and
a plurality of sampling rate lines for configuring the processor;
wherein an input signal having an input sampling frequency corresponding to at least one of the sampling rate lines, an output signal having an output sampling frequency corresponding to at least one of the sampling rate lines, wherein the processor converts the input samples corresponding to the first sampling rate to output samples corresponding to the second sampling rate using a single filter.

18. The selectable sampling rate converter of claim 17, wherein a first line comprises approximate sampling rates 8 kHz, 16 kHz, 32 kHz, and 64 kHz; a second line comprises approximate sampling rates of 12 khz, 48 kHz, and 96 kHz; and a third line comprises approximate sampling rates of 11.025 kHz, 22.05 kHz, and 44.1 kHz.

19. The selectable sampling rate converter of claim 17, further comprising a memory for storing a table of filter coefficients wherein the processor performs sampling rate conversion in real-time by incrementally indexing into the table.

20. The selectable sampling rate converter of claim 17, wherein the table contains half the number of coefficients necessary to realize one side of a symmetric function.
